(19) United States
(12) Patent Application Publication
(10) Pub. No.: US 2003/0198468 A1
(43) Pub. Date: Oct. 23, 2003

(54) Apparatus and method for developing an LCD

(76) Inventors: Yong-Seok Park, Seoul (KR); Jum-Lyul Han, Suwon-city (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/378,993

(22) Filed: Mar. 5, 2003

(30) Foreign Application Priority Data
Apr. 22, 2002 (KR) 2002-21948

(51) Int. Cl. G03D 3/00

(52) U.S. Cl. 396/564

(57) ABSTRACT

Provided are an apparatus and method for developing a large-sized liquid crystal display. The apparatus includes a bar-shaped developer spraying nozzle and a bar-shaped developer removing nozzle. The bar-shaped developer spraying nozzle is installed at a predetermined distance from a substrate and sprays a developer on the substrate. The bar-shaped developer removing nozzle is kept at a predetermined distance from a side of the developer spraying nozzle, collects the developer sprayed from the developer spraying nozzle in a vacuum state, and removes the sprayed developer. Accordingly, the apparatus and method can be applied to a rinsing process, a stripping process, a developing process, and an etching process.

### BACKGROUND OF THE INVENTION

This application claims the priority of Korean Patent Application No. 2002-21948, filed on Apr. 22, 2002, in the Korean Intellectual Property Office, the disclosure of which is incorporated herein in its entirety by reference.

1. Field of the Invention

The present invention relates to a liquid crystal display, and more particularly, to a developing apparatus and method used for developing, rinsing, stripping, and etching processes, performed to manufacture a liquid crystal display.

2. Description of the Related Art

A photolithographic process for a semiconductor substrate and a liquid crystal display (LCD) substrate is generally performed in the following order: a coating process for coating a substrate with a photoresist layer, an exposure process for radiating light onto the substrate to form a pattern, and a developing process for developing the exposed substrate.

FIGS. 1 through 5 are views for explaining an apparatus and method for developing a liquid crystal display (LCD) according to the prior art.

FIGS. 1 and 2 are plan views for explaining a process for coating a developer, and FIG. 3 is a cross-sectional view of FIG. 2. In detail, a substrate 1, which is used as an LCD, e.g., glass, is coated with a photoresist layer 30 and exposed to complete a pattern 20. The resultant structure is mounted on a spin chuck 50 in a developing apparatus, and then a developer spraying nozzle 10 moves toward the substrate 1, which has been exposed. Thereafter, the developer spraying nozzle 10 sprays a developer while moving along the direction indicated by the arrow shown in FIGS. 2 and 3, and thus a developer puddle 40 is formed. The resultant structure in which the developer puddle 40 is formed is developed by natural convection current while suspending for a predetermined period of time.

FIG. 4 is a cross-sectional view for explaining a process of removing a developer in a developing apparatus, and FIG. 5 is a cross-sectional view of a substrate that is completely developed. In detail, the substrate 1 coated with the photoresist layer 30 is completely developed. The developer is removed from the substrate 1 due to the spinning of the spin chuck 50. Thereafter, a rinsing solution is discharged from a rinsing solution supplying nozzle (not shown), and thus rinses the sprayed developer. Next, after the remaining developer and rinsing solution are completely removed by the spinning of the spin chuck 50, the series of processes is finished. Reference numerals 52 and 54 denote a shaft and a rotary motor, respectively.

However, the above-described method is suitable for a relatively small LCD. As the size of an LCD increases to about 1000 mm×1000 mm, it is quite difficult to mount the LCD on a spin chuck and remove a developer from the LCD by spinning of the spin chuck. Although a large developing apparatus may be used, limitations in installing the large developing apparatus and mechanical limitations in assembling a large developing apparatus will be accompanied.

### SUMMARY OF THE INVENTION

Accordingly, the present invention provides a developing apparatus for developing a large-sized LCD using a new method instead of an existing method.

The present invention also provides a method of developing an LCD using the developing apparatus.

According to an aspect of the present invention, there is provided an apparatus for developing a liquid crystal display. The apparatus includes a bar-shaped developer spraying nozzle and a bar-shaped developer removing nozzle. The bar-shaped developer spraying nozzle is installed at a predetermined distance from a substrate and sprays a developer on the substrate. The bar-shaped developer removing nozzle is kept at a predetermined distance from a side of the developer spraying nozzle, collects the developer sprayed from the developer spraying nozzle in a vacuum state, and removes the sprayed developer.

It is preferable that the predetermined distance of the bar-shaped developer spraying nozzle is within a range of 0.5-5 mm and the predetermined distance of the bar-shaped developer removing nozzle is within a range of 5-50 mm.

The apparatus may further include a developer spraying nozzle and a developer removing nozzle beside the bar-shaped developer removing nozzle.

According to another aspect of the present invention, there is also provided a method of developing a liquid crystal display. A substrate that is completely exposed is mounted on a chuck of a liquid crystal display developing apparatus. A developer is sprayed on the substrate using a developer spraying nozzle that is installed at a predetermined distance from the substrate. The sprayed developer is collected in a vacuum state using a developer removing nozzle that is kept at a predetermined distance from a side of the developer spraying nozzle and removing the collected developer.

Spraying and collecting the developer are performed as the chuck of the liquid crystal display developing apparatus moves in a predetermined direction or as the developer spraying nozzle and the developer removing nozzle move in a predetermined direction.

Spraying and collecting the developer can be efficiently performed using one or more developer spraying nozzles and one or more developer removing nozzles.

According to the present invention, a process of developing a large-sized LCD can be smoothly and efficiently performed. Also, by using one or more developer spraying nozzles and one or more developer removing nozzles, an efficiency of the developing process can be further increased and the time required for the developing process can be reduced.

### BRIEF DESCRIPTION OF THE DRAWINGS

The above features and advantages of the present invention will become more apparent by describing in detail exemplary embodiments thereof with reference to the attached drawings in which:

FIGS. 1 through 5 are views for explaining an apparatus and method for developing an LCD according to the prior art;

FIGS. 6 and 7 are views for explaining an apparatus and method for developing an LCD according to an embodiment of the present invention; and

FIGS. 8 and 9 are views for explaining an apparatus and method for developing an LCD according to another embodiment of the present invention.

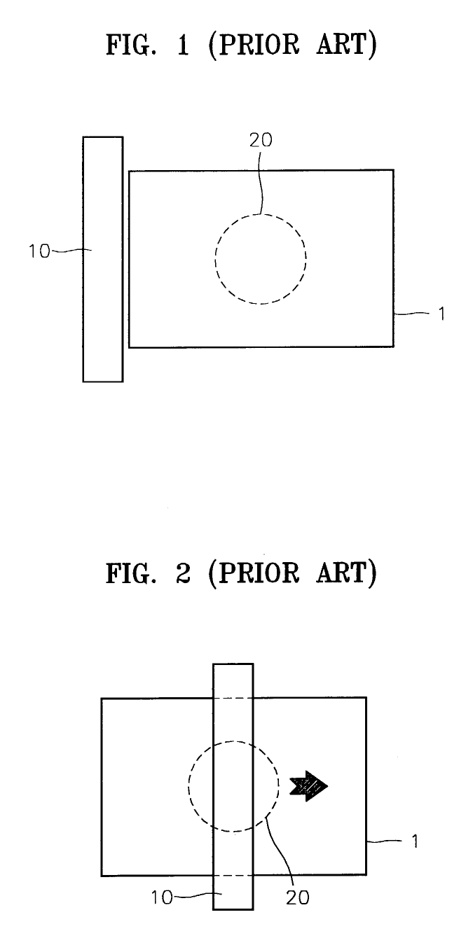

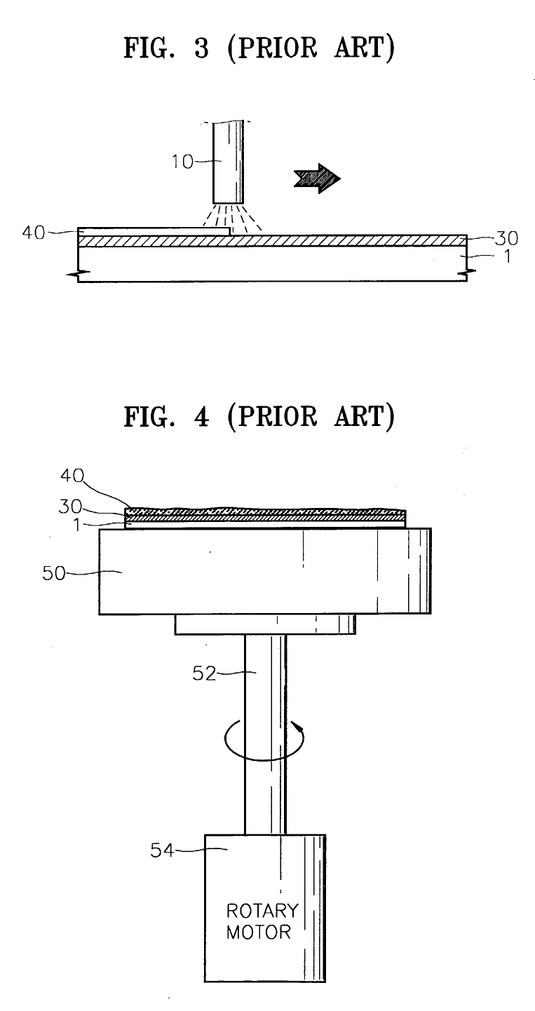

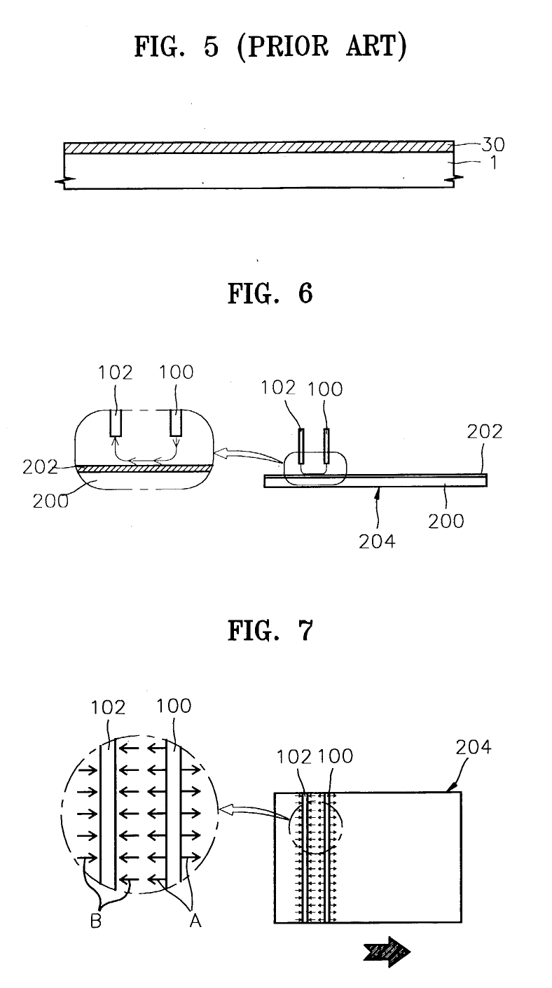

### DETAILED DESCRIPTION OF THE INVENTION

Hereinafter, preferred embodiments of the present invention will be described in detail with reference to the attached drawings.

FIGS. 6 and 7 are views for explaining an apparatus and method for developing an LCD according to an embodiment of the present invention.

FIG. 6 is a cross-sectional view for explaining an apparatus for developing an LCD according to the present invention. Referring to FIG. 6, the apparatus includes a developer spraying nozzle 100 and a developer removing nozzle 102. The developer spraying nozzle 100 is bar-shaped, installed at a distance of about 0.05-5 mm from a substrate 204, which is completely exposed, and sprays a developer on the substrate 204. The developer removing nozzle 102 is bar-shaped, kept at a distance of 5-50 mm from one side of the developer spraying nozzle 100, collects the developer sprayed from the developer spraying nozzle 100 in a vacuum state, and removes the developer. In FIG. 6, the arrow path represents a direction along which the developer is sprayed and collected. The substrate 204, which is completely exposed, refers to the resultant structure in which a glass layer 200 is coated with a photoresist layer 202 that is completely exposed. Thus, a large-sized LCD can be more efficiently developed using a developing method according to the present invention than an existing method, i.e., a method of spinning a substrate.

FIG. 7 is a plan view for explaining a method of developing an LCD using an LCD developing apparatus according to the present invention. In detail, the substrate 204, which is completely exposed, is mounted on a chuck (not shown) of a developing apparatus. Next, the developer spraying nozzle 100, which is installed at a predetermined distance from the substrate 204, sprays a developer, moving from left to right, i.e., in the large arrow direction. Thus, the developer is spread from the developer spraying nozzle 100 to the outside as shown by arrows A in FIG. 7. As shown by arrows B in FIG. 7, the developer removing nozzle 102, which is installed at a distance of 5-50 mm from the developer spraying nozzle 100, collects the sprayed developer in a vacuum state and removes the sprayed developer from the substrate 204.

Processes of spraying and collecting a developer may be performed as a chuck of a developing apparatus moves along the direction indicated by the large arrow in FIG. 7, with the developer spraying nozzle 100 and the developer removing nozzle 102 fixed. Alternatively, the processes of spraying and collecting a developer may be performed as the developer spraying nozzle 100 and the developer removing nozzle 102 move along the same direction with the chuck of the developing apparatus fixed.

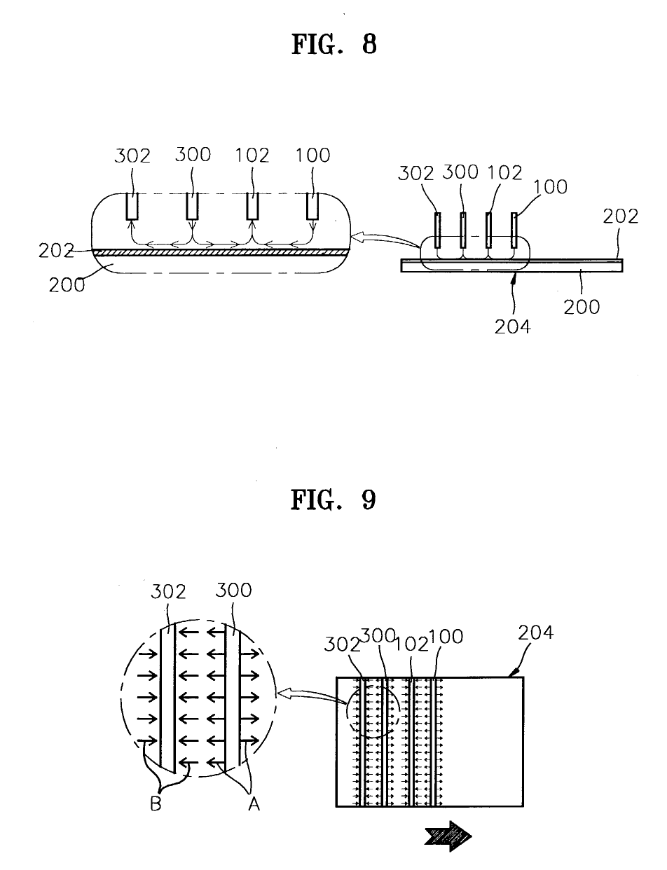

FIGS. 8 and 9 are views for explaining an apparatus and method for developing an LCD according to another embodiment of the present invention. Referring to FIGS. 8 and 9, in the present embodiment, a developer spraying nozzle 300 and a developer removing nozzle 302 are further included. Thus, the developer spraying nozzles 100 and 300 make a group and the developer removing nozzles 102 and 302 make another group. Therefore, a developing process can be further efficiently carried out and the time required for the developing process can be reduced.

Accordingly, according to the present invention, processes of developing, rinsing, stripping, and etching a substrate for a large LCD can be efficiently performed. Also, since one or more developer spraying nozzles and one or more developer removing nozzles can be installed, an efficiency of a developing process can be further increased and the time required for the developing process can be reduced.

The present invention can be carried out according to other various methods without departing from the spirit and scope of the present invention. For example, in the above-described embodiments, a developing apparatus is an apparatus using a developer spraying nozzle and a developer removing nozzle. However, the apparatus may be a rinsing apparatus, a stripping apparatus, or an etching apparatus. Also, a substrate for an LCD may be replaced with a wafer used in manufacturing a semiconductor device. Therefore, the present invention is not limited to the above-described embodiments and will be understood by those of ordinary skill in the art that various changes in form and details may be made therein without departing from the spirit and scope of the present invention as defined by the following claims.

What is claimed is:

1. An apparatus for developing a liquid crystal display, the apparatus comprising:
a bar-shaped developer spraying nozzle that is installed at a predetermined distance from a substrate and sprays a developer on the substrate; and
a bar-shaped developer removing nozzle that is kept at a predetermined distance from a side of the developer spraying nozzle, collects the developer sprayed from the developer spraying nozzle in a vacuum state, and removes the sprayed developer.

2. The apparatus of claim 1, wherein the predetermined distance of the bar-shaped developer spraying nozzle is within a range of 0.5-5 mm.

3. The apparatus of claim 1, wherein the predetermined distance of the bar-shaped developer removing nozzle is within a range of 5-50 mm.

4. The apparatus of claim 1, further comprising a developer spraying nozzle and a developer removing nozzle beside the bar-shaped developer removing nozzle.

5. A method of developing a liquid crystal display, the method comprising:
(a) mounting a substrate that is completely exposed on a chuck of a liquid crystal display developing apparatus;
(b) spraying a developer on the substrate using a developer spraying nozzle that is installed at a predetermined distance from the substrate; and
(c) collecting the sprayed developer in a vacuum state using a developer removing nozzle that is kept at a predetermined distance from a side of the developer spraying nozzle and removing the collected developer.

6. The method of claim 5, wherein steps (b) and (c) are performed as the chuck of the liquid crystal display developing apparatus moves in a predetermined direction.

7. The method of claim 5, wherein steps (b) and (c) are performed as the developer spraying nozzle and the developer removing nozzle move in a predetermined direction.

8. The method of claim 5, wherein steps (b) and (c) are efficiently performed using one or more developer spraying nozzles and one or more developer removing nozzles.
